(19) United States
(12) Patent Application Publication
(10) Pub. No.: US 2009/0248546 A1
(43) Pub. Date: Oct. 1, 2009

(54) Marketing System And Method

(76) Inventors: Jon Norris, Kenmore, NY (US); Garrett Ausfeldt, Williamsville, NY (US)

Correspondence Address: HODGSON RUSS LLP;THE GUARANTY BUILDING, 140 PEARL STREET, SUITE 100, BUFFALO, NY, 14202-4040, US

(21) Appl. No.: 12/357,347

(22) Filed: Jan. 21, 2009

Related U.S. Application Data
(60) Provisional application No. 61/022,055, filed on Jan. 18, 2008.

(51) Int. Cl. G06Q 30/00; G06F 3/048

(52) U.S. Cl. 705/27; 715/764

(57) ABSTRACT

A method for marketing products, by selecting a product having a product identifier from a catalog, entering the product identifier into an online computer system, and using the online computer system to generate a customized sales sheet. The catalog may be in an abbreviated format to reduce the size and/or weight, and may include product codes enabling more expeditious access to the product information in the online system. The sales sheets are customizable with such information as product images complete with logos specific to a retail customer, a distributor, or both. The invention may also be embodied as a system for producing marketing materials.

### CROSS-REFERENCE TO RELATED APPLICATIONS

This application claims the benefit of priority to U.S. provisional patent application Ser. No. 61/022,055, filed on Jan. 18, 2008, now pending, the disclosure of which is incorporated herein by reference.

### FIELD OF THE INVENTION

This invention pertains to the field of catalog or Internet ordering of commercial goods, especially promotional products.

### BACKGROUND OF THE INVENTION

As industries mature and production costs decrease, catalog order companies are able to offer a wider variety of products to their clientele. Suppliers of promotional products, for example, may offer over 500 different products customizable with company logos, text, or other symbols with more products added at a fast rate. In industries that utilize catalog-based ordering, this has created catalogs which are unwieldy, expensive to produce, expensive to ship, and intimidating to end-users.

Additionally, distributors of catalog products vary in size and capability from large distributors with full-time marketing staff, to small distributors possibly consisting of one person working out of their home. Such small distributors may not have the resources to generate robust marketing materials that are customized for their customers. For example, in the promotional products industry, it is preferable to show a potential buyer a view of the product complete with the logo of that customer. Creating such a sales sheet requires considerable effort on the part of the distributor.

Accordingly, there is a need for a streamlined sales system and method that reduces the use of bulky catalogs.

### BRIEF SUMMARY OF THE INVENTION

The present invention meets the above need by providing a method and system for creating customizable sales sheets for products. It is an aspect of this invention is to provide a system and method by which suppliers, distributors, and retail customers can create customizable product sales sheets. These sales sheets may include product descriptions, pricing, shipping information, dimensions, and preferably product images complete with the logos of the retail customer, the distributor, or both.

It is a further aspect of this invention to allow for an abbreviated product catalog, or product digest. Such a product digest may be a companion book to a full product reference catalog. The product digest contains only a subset of the product information contained in the reference catalog. In this manner, the present invention achieves an objective of providing a catalog that is easier to use and less expensive to produce and ship.

### DESCRIPTION OF THE DRAWINGS

For a fuller understanding of the nature and objects of the invention, reference should be made to the following detailed description taken in conjunction with the accompanying drawings, in which:

FIG. 1 is a flowchart depicting a method according to the present invention;

FIG. 2 is an example of a sales sheet according to the present invention;

FIG. 3 is another example of a sales sheet according to the present invention;

FIG. 4 is a screen capture of a sales sheet tool according to the present invention;

FIG. 5 is a screen capture of a logo upload dialog box of a sales sheet tool;

FIG. 6 is a screen capture of a product imprinting screen;

FIG. 7 is a schematic showing a product carousel according to the invention;

FIG. 8 is a system according to another embodiment of the present invention;

FIG. 9 is a screen capture of an online computer system according to the present invention; and

FIG. 10 depicts a system according to another embodiment of the invention.

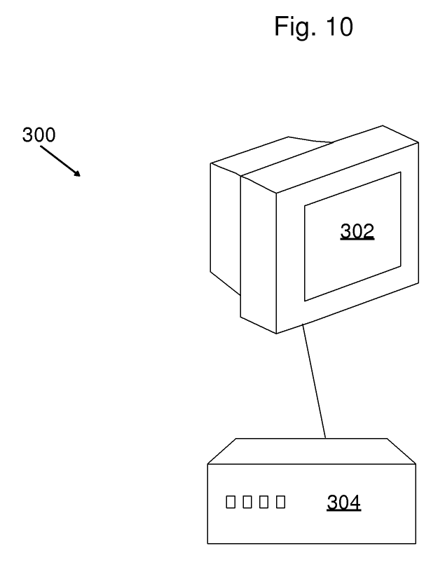

### DETAILED DESCRIPTION OF THE INVENTION

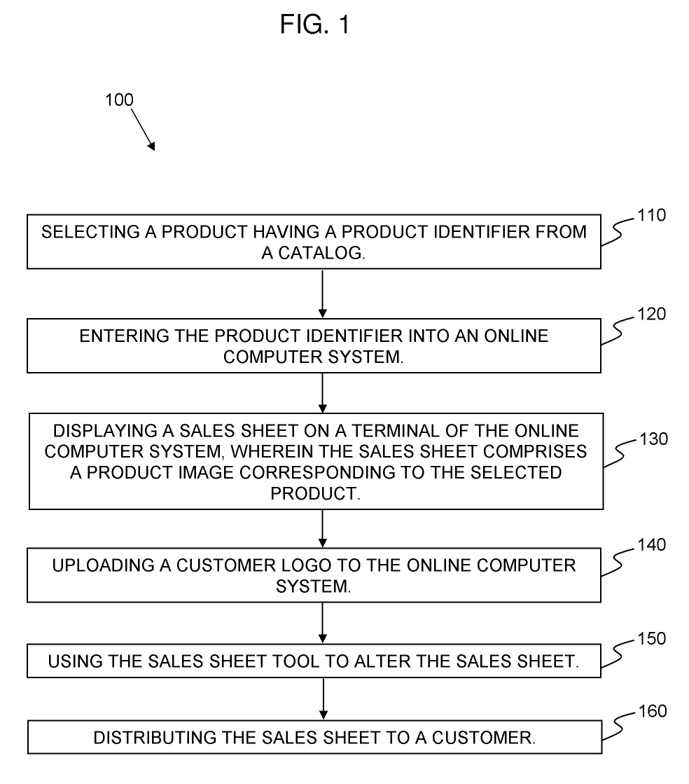

Referring to FIG. 1, a flowchart of a method 100 according to the present invention is shown. The method generally comprises a catalog that contains information related to products available from a supplier. Such product information may include a product name and number, and may further include an image of the product, a product description, a product identification, and the like. The catalog may be provided by the supplier to a distributor by mail or other method commonly known. The distributor may use the catalog to purchase products from the supplier and may offer products for sale to a retail customer. Alternatively, the supplier may provide the catalog directly to a retail customer.

A user of the online system may be the distributor, wherein the distributor may, for example, be preparing for a sales call to a retail customer. The user may also be the retail customer itself wherein it was provided a catalog. The retail customer may have been provided a copy of the catalog through mail distribution, or as the result of a meeting with the distributor. The user may also be the supplier, wherein the supplier may have been contacted by a distributor or a retail customer to generate a sales sheet for them. A user may select 110 a desired product from the catalog. For example, if the user is a distributor, the user may select 110 a product from the catalog which they believe will be of interest to one or more of the distributor's customers. The user may make note of a product identifier of the selected product. The product identifier may be any of the product information unique to the selected product, for example, the name of the product, the product number, the product identification, etc.

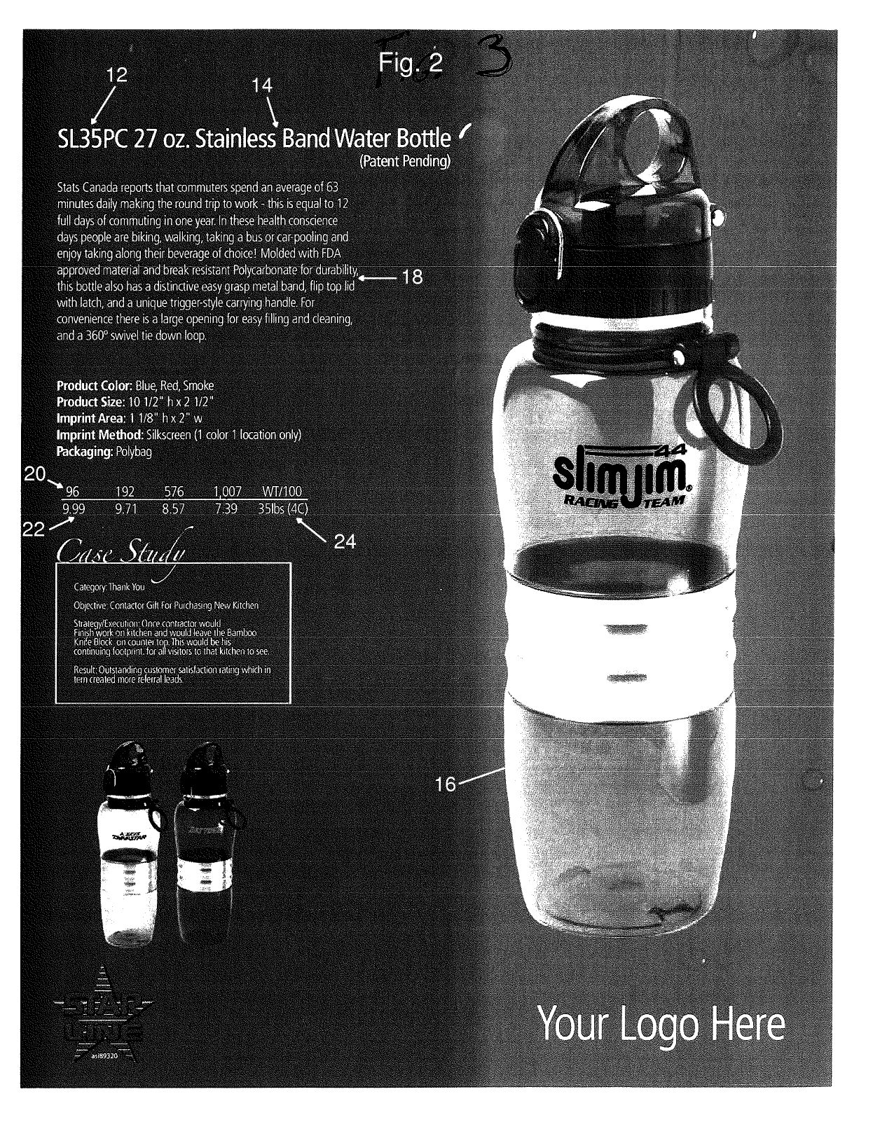

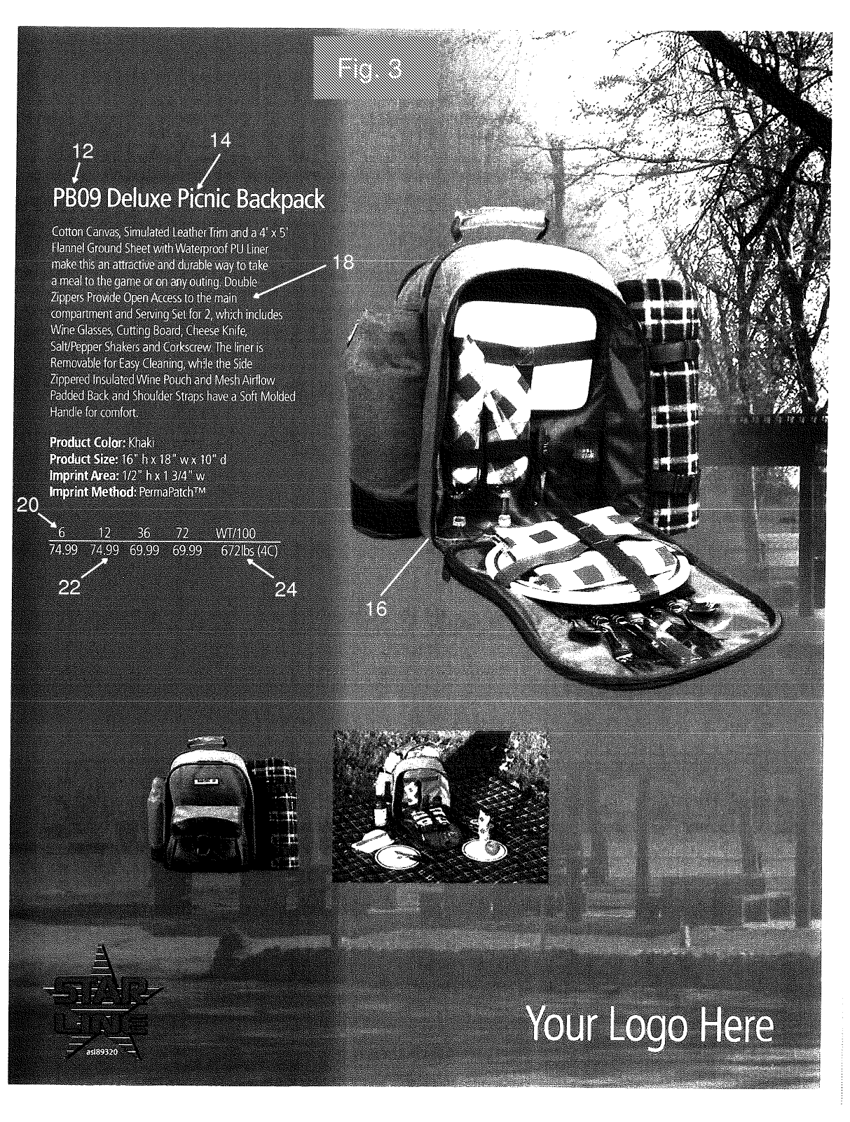

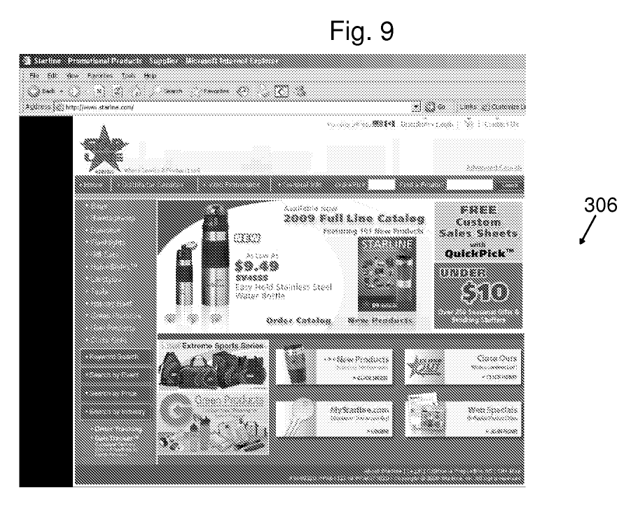

The user may access an online computer system using a computer terminal. The online computer system may be, for example, the website of the supplier (see, e.g., FIG. 9). The computer terminal may be any computer used to access the online computer system, such as, for example, a computer with a web browser or a cellular telephone with a web browser (for example, a “smartphone”). The online computer system may contain information for each of the products listed in the catalog. Such information may be searchable (for example, product name, product number, etc.) and/or non-searchable (for example, an image of the product). The user may enter 120 the product identifier in a field of the online computer system. The online computer system may generate a sales sheet 10 (see, e.g., FIGS. 2 and 3) for the selected product and display 130 the sales sheet 10 on the user's computer terminal.

A sales sheet 10 may be any format of marketing literature. For example, a sales sheet 10 may be a tri-fold brochure or a single sheet flyer. The sales sheet 10 may comprise an image 16 of the selected product. The sales sheet 10 may further include the product number 12, product name 14, a description of the product 18, a description of how the product is sold (for example, ordering quantities 20), pricing information 22, shipping information 24, or any other information which may be of interest to the intended audience of the sales sheet 10.

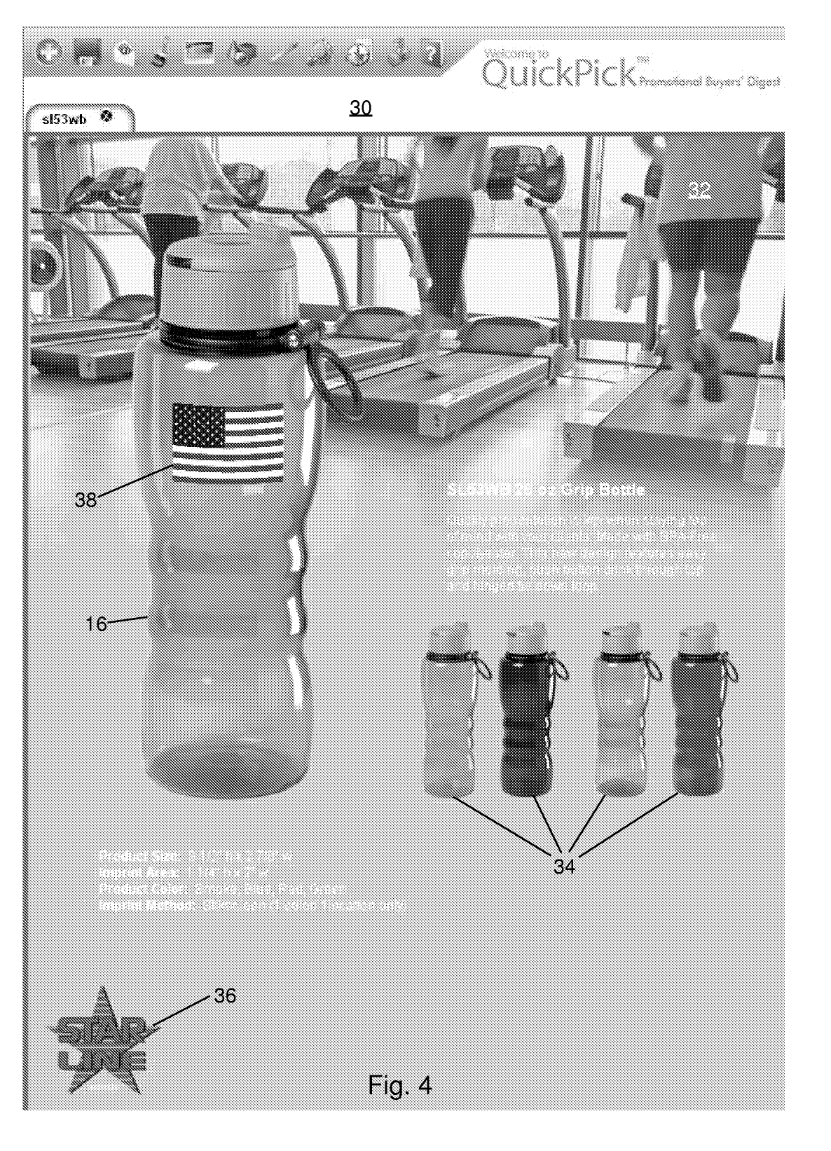

The sales sheet 10 may be displayed in a sales sheet tool 30 on the terminal (see, e.g., FIG. 4). Such a sales sheet tool 30 may allow the user to alter 150 the sales sheet 10 to suit the user's particular needs. For example, the user may select certain of the aforementioned information for display on the sales sheet. The user may reposition and/or resize any of the information or images on the sales sheet. The user may change a background image 32 of the sales sheet 10. The user may also add, remove, or replace product images 34, for example, to show the product in multiple available colors.

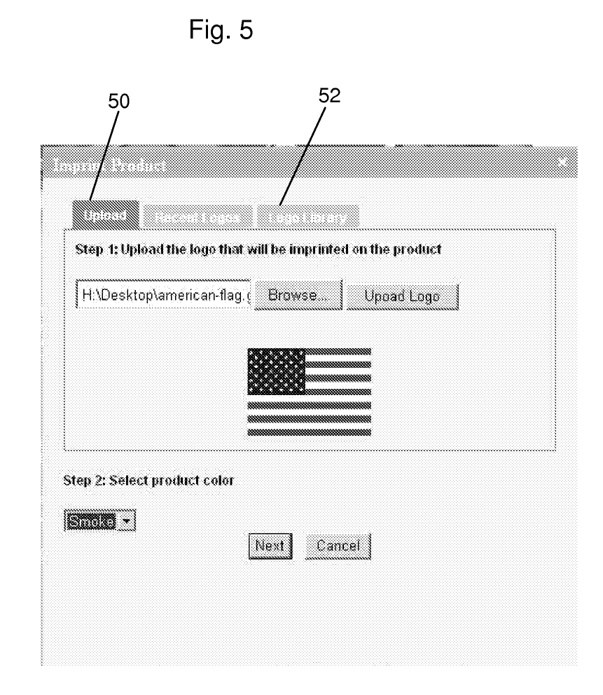

The sales sheet 10 may also include one or more logos 36 of the supplier, the distributor, the retail customer, or any combination of these. The number, size, and placement of these logos may be customized by the user. The logo(s) 36 may be stored 52 on the online computer system, or the logo(s) may be uploaded 140 by the user 50 (see, e.g., FIG. 5).

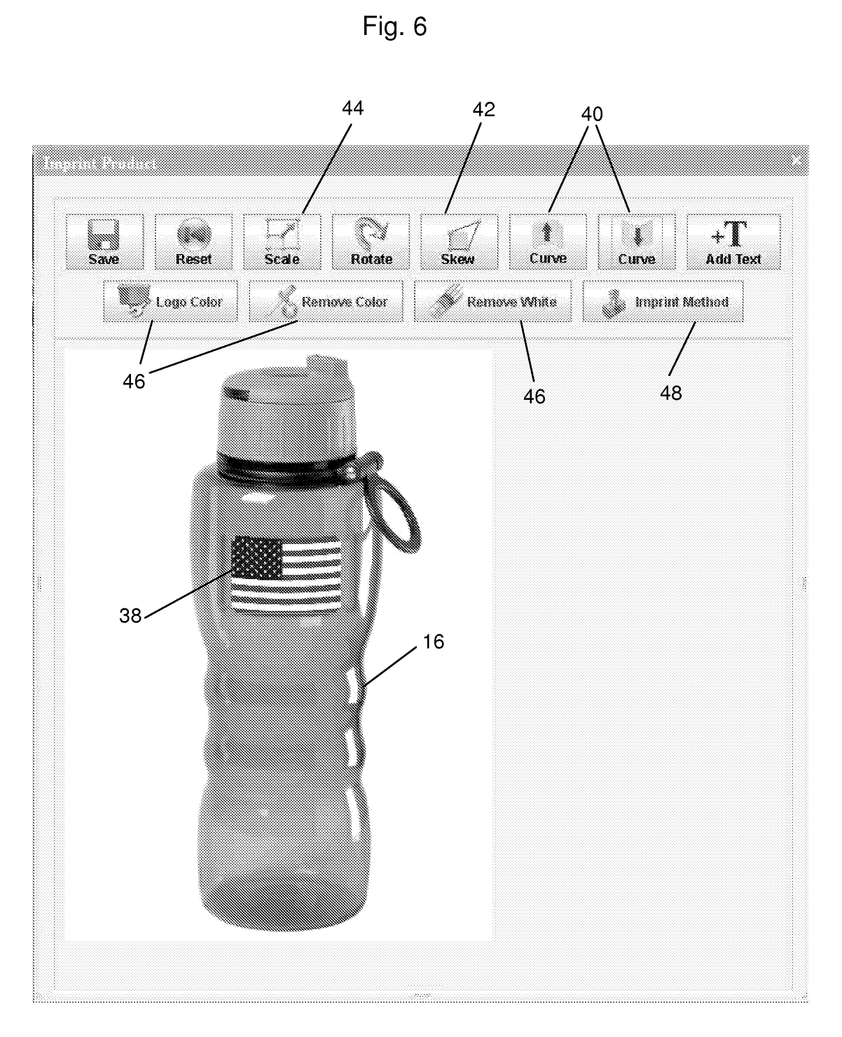

The user may also overlay a logo 38 on the product image 16 to depict on the sales sheet 10 what a physical product will look like with a logo 38 imprinted upon it. FIG. 6 depicts one example of a product imprinting screen. The logo 38 overlay may be edited to impart a curve 40 to the logo 38 such that the perspective of the logo 38 matches the perspective of the product image 16. Similarly, the logo 38 may be reshaped, or skewed 42, to match a perspective of the product image 16. The logo 38 may also be resized 44 or re-colored 46 to provide a more realistic representation of the physical product. The method of imprinting 48 may be selected by the user to better depict the physical product. For example, the user may select silkscreening, engraving, or debossing—each of which will affect the display of the logo 38 overlay to represent the physical product. Other imprinting methods will be readily apparent to those skilled in the art.

The sales sheet 10 may be distributed to the user by any method, for example, e-mail, mail, CD, paper. The online computer system may also allow the user to create sales sheets 10 for multiple products. The multiple sales sheets 10 may be distributed by any of the aforementioned means. The user may cause the online computer system to distribute 160 the sales sheet to another party, for example, a distributor may use the online computer system to distribute 160 a customized sales sheet directly to a retail customer.

The catalog may be a product digest. A product digest may be an abbreviated catalog. In this manner, the product digest may contain smaller product images and/or less detailed information for each product such that the product digest may be smaller in size and more cost effective to produce and ship.

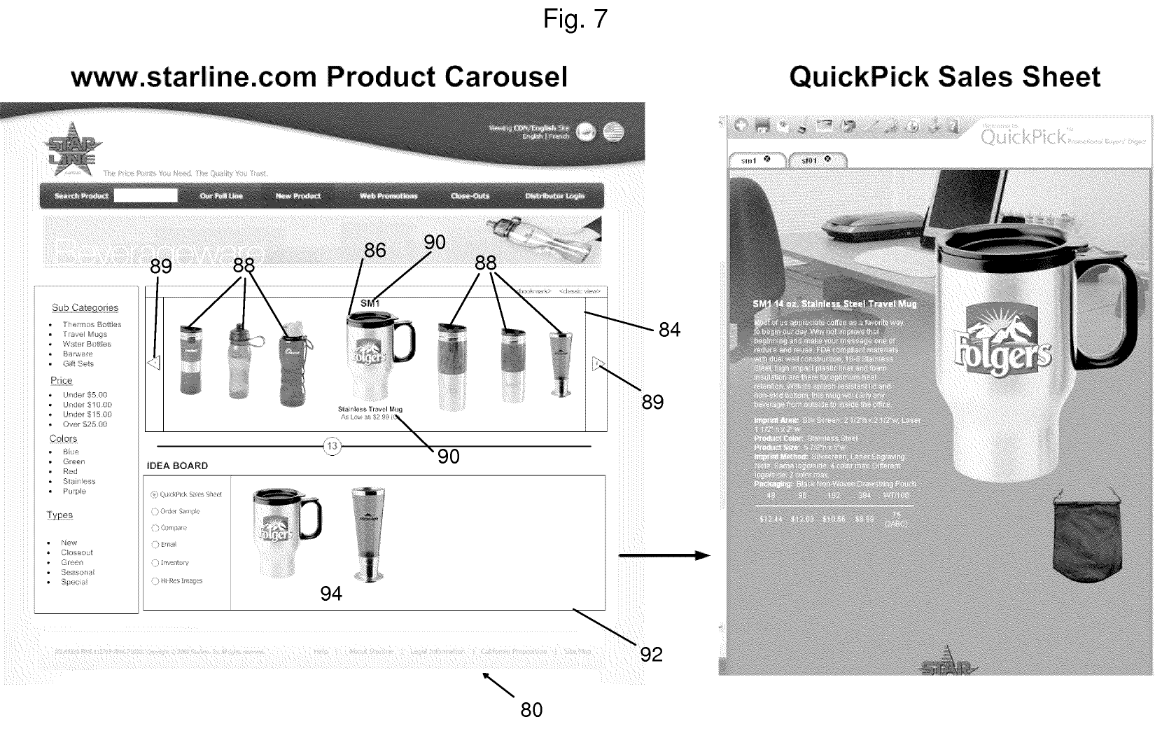

Alternatively, the catalog may consist of an online catalog such that no printing or shipping costs are incurred at all. The online catalog may have a “carousel” layout as shown in FIG. 7. A portion 82 of a webpage 80 may contain a carousel window 84. The carousel window 84 may display a primary product image 86 and at least one secondary product image 88 adjacent to the primary product image 86. The primary product image 86 may be displayed differently than the secondary product image 88; for example, the sizes of the images 86, 88 may be different or the images 86, 88 may have differently colored backgrounds. The carousel window 84 may also contain at least one advancement button 89. When a user selects the at least one advancement button 89, the primary product image 86 may become a secondary product image 88, and the former secondary product image 88 may move to become the new primary product image 86. A new secondary image 88 may be displayed. In this way, a user may have the impression of being able to advance through a queue of product images 86, 88 by clicking the advancement button 89. More than one advancement button 89 may be provided such that the user may advance the product images 86, 88 in either direction. The carousel window 84 may be oriented in any direction so that the product images 86, 88 may be scrolled up and down, or side to side, or in any other direction.

Additional information 90 may be displayed corresponding to the primary product image 88. The user may perform additional operations on the primary product image 86 such as, for example, dragging the primary product image 86 to a holding area 92. The holding area 92 may store one or more products of interest 94. Further operations, such as, for example, creating sales sheets may be performed on the one or more products of interest 94 stored in the holding area 92.

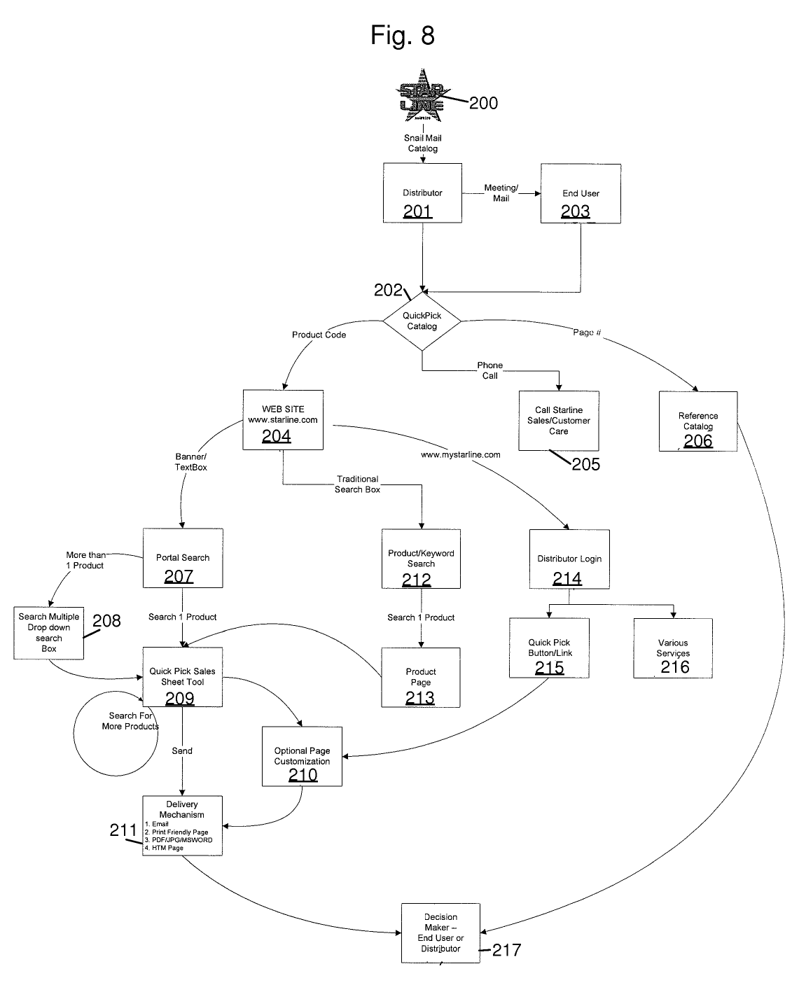

FIG. 8 depicts a non-limiting example of a sales system utilizing the method described above. A product of interest is selected from a product digest 202 and a product code obtained. The product code is entered into an online system preferably a website having a search box. FIG. 2 shows an example website wherein the search box is labeled “QuickPick.” The online system automatically builds a sales sheet for the product which may include information useful to a decision-maker 217, such as a product image, description, pricing, options, and the like.

The supplier may also publish a full catalog 206 wherein further details related to the product are disclosed. The product digest may contain information that refers to the reference catalog, for example a page number. The reference catalog may be distributed to the client, the distributor, or other interested parties. Referrals from the reference catalog may be processed using well-known ordering methods (e.g. telephone ordering, order forms through mail), or the reference catalog itself may be an entry point to the online system described more fully above.

The online system may further comprise a traditional search box for the purposes of, for example, product and keyword searching. The online system may allow the user to process the results of such a traditional search through the sales sheet creation process as outlined above.

The online system may further comprise a distributor portal wherein the distributor may have a customized interface into the online system for service management. The portal may contain logo libraries specific to the distributor and the distributor's clients. The portal may also contain an address book wherein details of the distributor's clients are stored. The details may include such information as communication preference for sales sheets. The portal may also include the capability for distributors to store a previously made sales sheet.

Referring again to FIG. 8, the supplier 200 distributes two catalogs, the product digest and the reference catalog to the distributor 201. The distributor 201 may further distribute the materials to the end user 203. The distributor 201 or the end user 203 may select a product from the product digest 202.

The product code listed in the product digest 202 may be used within the supplier website 204 by entering the code in the portal search field 207. If multiple items are to be searched, the user may search using the “search multiple” drop down search box 208. A more traditional product or keyword search 212 may be performed instead of the portal search 207. The product or keyword search 212 will show results as a product page 213.

The results of the any of the aforementioned search options will be directed to the sales sheet tool 209. Additional searches may be performed and added to the sale sheet tool 209. The user now has the option of customizing the page 210 before delivering the sales sheet in various forms 211 to the decision maker 217.

A distributor may choose to login to the portal 214 and use product digest buttons 215 to select products directly and proceed to the customization module 210 before delivering the sales sheets 211 to the decision maker 217.

Alternatively, once selecting at least one product from the product digest 202, the distributor 201 or end user 203 may contact the supplier directly by phone 205 to obtain additional product information.

A third alternative exists where the distributor 201 or end user 203 may use the product digest 202 to identify products for further research in the traditional reference catalog 206. The product information obtained from the reference catalog 206 may then be sent through traditional methods to the decision maker 217.

The invention may also be embodied as a system 300 for producing customized marketing materials. The system 300 may have a display 302 and a computer 304 in communication with the display 302. The display 302 may be a web client and the computer 304 may be a web server. In this manner, the web client and the web server may communicate via the Internet. The computer 304 may be programmed to query a user for a product of interest. The computer 304 may query a user using a web interface such as the QuickPick tool 306 shown in FIG. 9. The user may enter a product of interest by, for example, entering a product identifier in response to the query. The computer 304 may be programmed to generate a sales sheet 10 for the product entered by the user. The computer 304 may be programmed to display the generated sales sheet 10 to the user via the display 302. The computer 304 may additionally be programmed to allow the user to alter the displayed sales sheet 10, for example, by way of a sales sheet tool 30, such as, for example, that depicted in FIG. 4. The computer 304 may also be programmed to distribute the sales sheet 10 by way of, for example, e-mail, mail, printing, or otherwise.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A method for generating product marketing materials, comprising the steps of:
selecting a product having a product identifier from a catalog;
entering the product identifier into an online computer system;
displaying a sales sheet on a terminal of the online computer system, wherein the sales sheet comprises a product image corresponding to the selected product.

2. The method of claim 1, wherein the catalog is a product digest.

3. The method of claim 1, wherein the catalog is an online catalog.

4. The method of claim 1, wherein the sales sheet further comprises a customer logo corresponding to a retail customer.

5. The method of claim 4, further comprising the step of uploading the customer logo to the online computer system.

6. The method of claim 4, wherein the customer logo is stored in the online computer system.

7. The method of claim 4, wherein the customer logo is overlaid on the product image to depict the product having an imprinted customer logo.

8. The method of claim 1, wherein the sales sheet further comprises a distributor logo.

9. The method of claim 1, wherein the sales sheet further comprises at least one product information field, wherein the at least one product information field is selectably displayed and the location of the product information field is determined by a user.

10. The method of claim 1, further comprising the step of distributing the sales sheet to a customer.

11. The method of claim 10, wherein the sales sheet is distributed by e-mail.

12. The method of claim 1, wherein the online computer system further comprises a sales sheet tool for altering the displayed sales sheet.

13. The method of claim 12, further comprising the step of using the sales sheet tool to alter the sales sheet.

14. A system for producing marketing materials, comprising:
a display;
a computer in communication with the display, wherein the computer is programmed to:
query a user for a product of interest;
generate a sales sheet corresponding to the product of interest; and
display the sales sheet on the display.

15. The system of claim 14, wherein computer is further programmed to allow the user to alter the displayed sales sheet.

16. The system of claim 14, wherein the computer is further programmed to distribute the displayed sales sheet.
